(19) United States
(12) Patent Application Publication
(10) Pub. No.: US 2010/0257218 A1
(43) Pub. Date: Oct. 7, 2010

(54) MERGING MULTIPLE HETEROGENEOUS FILE SYSTEMS INTO A SINGLE VIRTUAL UNIFIED FILE SYSTEM

(76) Inventors: Konstantin Iliev Vassilev, Sofia (BG); Vesselin Ivanov Batzarov, Sofia (BG); Nedko Vesselinov Arnaudov, Sofia (BG); Alexander Asenov Lefterov, Sofia (BG); Bernard Lamborelle, Montreal (CA); Robert Keske, New York, NY (US)

Correspondence Address: PATENT DOCKET CLERK;COWAN, LIEBOWITZ & LATMAN, P.C., 1133 AVENUE OF THE AMERICAS, NEW YORK, NY, 10036, US

(21) Appl. No.: 12/754,272

(22) Filed: Apr. 5, 2010

Related U.S. Application Data
(60) Provisional application No. 61/166,409, filed on Apr. 3, 2009.

(51) Int. Cl. G06F 17/30

(52) U.S. Cl. 707/823; 707/E17.01

(57) ABSTRACT

The present invention is a virtual unified file system designed to be implemented on multiple operating systems and comprised of multiple sub-file systems. The virtual unified file system presents to the user space of the operating system on which it is implemented a virtual unified file structure incorporating the file structure of each integrated sub-file system. The virtual unified file system includes a universal protocol, converter modules and unify module. The universal protocol includes file system operations common to all existing file system while allowing for an arbitrary number of extensions and exceptions. The converter modules provide for conversion between specific protocols native to specific file system and the universal protocol. The unify unit processes universal protocol command calls and present a virtual unified file structure to the user space that is implementing the virtual unified file system. In presenting a virtual unified file structure to the user space, the virtual unified file system provides for resolution of file name and file data path conflicts. In distributing data across multiple integrated sub-file system, the virtual unified file system provides for run-timer and off-line methods for distributing files.

### RELATED APPLICATION

This application claims the benefit of U.S. provisional patent application No. 61/166,409, filed Apr. 3, 2009, in the names of Konstantin Lliev Vassilev, Vesselin Ivanov Batzarov, Nedko Vesselinov Arnaudov, Alexander Asenov Lefterov, Bernard Lamborelle and Robert Keske, the disclosure of which is incorporated herein by reference.

### FIELD OF THE INVENTION

The present invention relates to a method of creating and exposing a virtual unified file system composed of multiple sub-file systems, the virtual unified file system comprised of those features and attributes common to all integrated sub-file systems.

### BACKGROUND OF THE INVENTION

A file system is a software component of a computer operating system that controls the allocation of disk storage to a folder and a folder structure used by applications running on the operating system to ensure data continuity and persistence. Examples of traditional file systems spanning across multiple operating systems includes ext3, FAT, FAT32, NTFS, HFS+, XFS and ZFS.

The traditional file system is created against a scheme of logical volume devices and physical disk devices. A logical volume device is itself comprised of one or more physical disk devices. The layout of the data on the volume device being dependent on the actual size of the volume. There are inherent deficiencies with this traditional file system scheme.

Data rates have increased exponentially. While the cost of storage has decreased, there are a very limited number of options which provide for resizing an existing store that is full. Some volume management systems support methods of extending existing volume devices with new physical disks and there are third party tools which resize traditional file systems to fit a larger volume device. However, these methods and the third party tools all require taking the file system offline and performing lengthy and risky maintenance operations. In a large modern storage system, these maintenance operations can take days to complete.

Similarly, a large volume device containing unused physical space that would be better served on other volume devices is limited by these same resizing restrictions. In other words, to free up the unused physical space from the large volume so it may be used elsewhere requires taking the file system on the large volume device offline and performing lengthy and risky maintenance operations which could take days to complete.

This resizing limitation associated with traditional file systems has its roots in the fact that a volume device cannot have a physical disk added or removed without reformatting the file system that is using that volume device. Reformatting a file system usually requires moving data from that volume device out to temporary storage which also can be a lengthy operation where large amounts of data are involved.

Concurrent with the exponential rise in data rates is the development of affordable newer and faster storage technologies. Vintage storage technologies cannot easily and safely merge with these newer technologies. Rather, storage systems based on older technologies must be discarded and their data must be either migrated to newer storage systems or left on separate volumes based on different technologies. Storage systems which incorporate multiple separate volumes inevitably lead to management and user access issues.

Although having a single repository for all data provides ease of use in any storage system configuration, there is an inherent problem with such a configuration. If the file system goes down or becomes corrupt, the amount of possible data loss and the amount of time associated with restoring the data through the rebuilding of the file system increases along with the size of the file system.

Although traditional file systems do provide some flexibility they are still limited in many respects. Thus, there still exists a need for various improvements to the traditional file system.

### DEFINITIONS

The following definitions are provided for convenience and are not to be taken as a limitation of the present invention.

Logical Unit Number (“LUN”): a number assigned to a logical unit defined under the Small Computer System Interface (“SCSI”), the logical unit comprised of multiple block based physical disks.

Block Access: a method of accessing physical storage devices including a physical hard disk, flash memory and a LUN, as an array of equally sized blocks.

Block Device: a storage device which operates only through block access. The minimum amount a user can read from or write to a block device is one block. Each block device supports one or more specific block sizes, also known as that device's granularity.

Disk Device: operating system abstraction of a physical or SCSI device to a system. A disk device provides block access for reading and writing data.

Volume Device: operating system abstraction of a logical storage unit. A volume device provides block access for reading and writing data. A volume device uses one or more disk devices to store data thereby adding speed and redundancy to a storage system configuration.

File System: an operating system component responsible for handling logical I/O operations. File systems typically have a hierarchal structure comprised of folders and files and provide a range of features including keeping track of when a file is accessed, defining an owner for a file, providing for permission based access to the directories and files.

Metadata: attributes assigned to folders and files which are representative of the actual content of the files.

Virtual Unified File System: a file system that stores data across integrated sub-file systems.

Sub-file System: a file system that is used by a virtual unified file system to store data.

File System Features: a set of functions and limitations attributable to a file system. Limitations include maximum file name length and exclusion of certain characters from use in a file name. Functions include timestamps and journaling.

File System Protocol: a set of functions used and structures used by an operating system to interact with a file system. A file system protocol is dependent on a particular file system's set of file system features.

Universal File System Protocol: the protocol used by a virtual unified file system which is a super set of all supported file system protocols.

File Path: the general form of a file or directory name which specifies a unique location in a file system.

Mounting: attaching the virtual unified file system to a tree structure accessible to the operating system implementing the virtual unified file system.

### SUMMARY OF THE INVENTION

It is the primary purpose of the present invention to obviate the above problems by providing a virtual unified file system comprised of multiple traditional sub-file systems having features and capabilities not currently available in traditional file systems.

To accomplish this objective, according to one embodiment of the present invention, there is provided a series of instructions on a non-transitory storage medium accessible to a computer, the instructions causing the computer to implement a virtual unified file system comprising: an operating system module implementing a native file system protocol and mounting the virtual unified file system via the local native file system protocol, a logical file storage interface module within the virtual unified file system processing logical file storage calls originating from the operating system using the native file system protocol to one or more independent sub-file systems implementing block-based storage devices, converter modules within the virtual unified file system converting between the native file system protocol and a universal protocol and converting between the universal protocol and multiple non-native file system protocols implemented by the one or more independent sub-file systems but not implemented by the operating system module, and a unify module within the virtual unified file system operating on the universal protocol to perform operational logic necessary to implement service requests by issuing one or more requests to each of the independent sub-file systems and generating a unified result for a logical file storage call originating from the operating system using the native file system protocol.

In accordance with another embodiment of the present invention, there is provided a computer-implemented method for controlling the presentation of a virtual unified file system, the method comprising: implementing a native file system protocol within an operating system, mounting the virtual unified file system via the native file system protocol, processing by a logical file storage module within the virtual unified file system of logical file storage calls originating from the operating system using the native file system protocol to one or more independent sub-file systems implementing block-based storage devices, concerting by converter modules within the virtual unified file system between the native file system protocol and a universal protocol and converting between the universal protocol and multiple non-native file system protocols implemented by the one or more independent sub-file systems but not implemented by the operating system module and operating on the universal protocol by a unify module within the virtual unified file system to perform operational logic necessary to implement service requests by issuing one or more requests to each of the one or more independent sub-file systems and generating a unified result for a logical file storage call originating from the operating system using the native file system protocol.

In accordance with yet another embodiment of the present invention, there is provided a logical layer based virtual unified file system sitting above and comprised of multiple integrated block based sub-file systems. The operating system that is implementing the virtual unified file system communicates with each integrated sub-file system so as to effectively present those features and capabilities which are common to all the sub-file systems as accessible features and capabilities of the virtual unified file systems. This virtual unified file systems feature set presents multiple independent storage systems running on multiple integrated sub-file systems as a single virtual unified logical file storage system. In this implementation of the virtual unified file system, each integrated sub-file system continues to provide block based I/O of data and corresponding metadata to each individual storage systems while simultaneously logically merging each sub-file system under a single virtual unified file system.

In addition to the foregoing, other features, objects and advantages of the present invention will become apparent from the following description.

### BRIEF DESCRIPTION OF THE DRAWINGS

The following detailed description, given by way of example and not intended to limit the present invention solely thereto, will best be appreciated in conjunction with the accompanying drawings in which:

FIG. 1 is a functional block diagram of a traditional file system that may be integrated within the virtual unified file system of the present invention;

FIG. 2 is a functional block diagram of the command structure between a virtual unified file system and integrated sub-file systems; and

FIG. 3 is a diagram of one possible embodiment of how integrated sub-file systems integrated are presented to a user space in accordance with the present invention.

### DETAILED DESCRIPTION OF THE INVENTION

The present invention relates to a virtual unified file system comprised of multiple traditional sub-file systems having features and capabilities not currently available in traditional file systems.

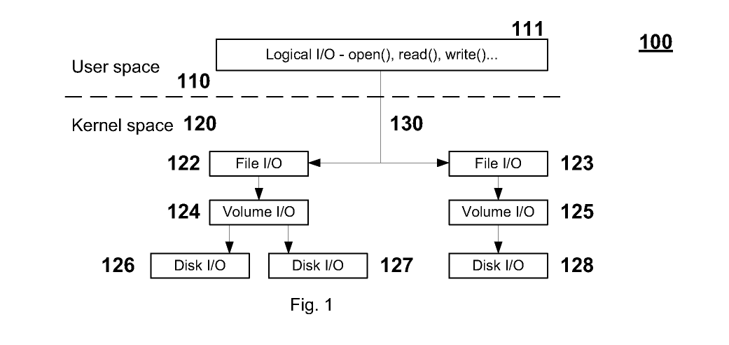

FIG. 1 of the accompanying drawings is a general functional depiction of a traditional file system that may be integrated as a sub-file system within the virtual unified file system of the present invention. Each sub-file system may be implemented on a variety of known operating systems including Windows, Apple OS, Linux and Unix.

As shown, an operating system 100 is functionally divided into a user space 110 and a kernel space 120. The user space 110 includes a logical I/O interface 111 which processes logical I/O calls to one or more file systems implemented within the kernel space 120. Logical I/O calls originating from within user space 110 are implemented through a protocol native to those file systems supported by operating system 100. Typical I/O calls include such standard file system commands as open, read and write or any other call to an operation known to be implemented within a specific file system.

As shown, kernel space 120 includes a first file system 122 and a second file system 123. Each file system controls the layout of and the internal links to the data files and the corresponding metadata files within a volume device. Specifically, file system 122 controls access to a volume device 124 and file system 123 controls access to a volume device 125. Metadata files include such information on corresponding data files as a data file's name, attributes, ownership and access permissions.

Each volume device is itself comprised of one or more disk devices. As shown, volume device 124 is comprised of two separate disk devices 126 and 127 and volume device 125 is comprised of a single disk device 128. Each disk device represents a physical storage device consisting of an array of equally sized blocks of binary data, such devices including hard disks, flash memory and CD ROMs. The purpose of volume devices 124 and 125 is to hide from the user the complexity of the layout of data on the multiple disk devices as well as to provide redundancy and increased speed. Several different strategies for combining physical disks into volume devices are available, the most popular being RAID0, RAID1 and RAID3.

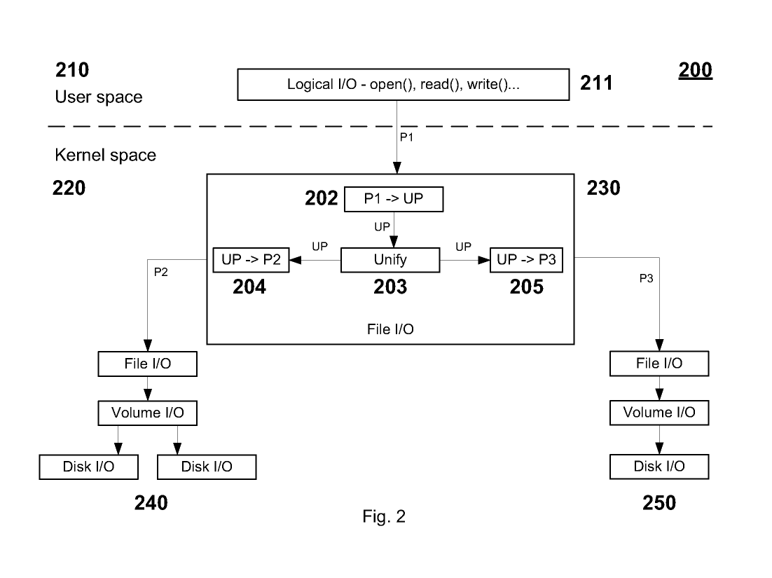

The virtual unified file system of the present invention is comprised of multiple sub-file systems, each sub-file system being similar to the standard file system described above. FIG. 2 is a high-level block diagram showing one implementation of the virtual unified file system. As shown, a virtual unified file system 200 is functionally divided into a user space 210 and a kernel space 220. User space 210 includes a logical I/O interface 211. Kernel space 220 includes a first sub-file system 240, a second sub-file system 250 and a file I/O module 230.

Logical I/O interface 211 processes service requests that originate from within user space 210 and that are addressed to a file system within kernel space 220. The virtual unified file system, itself being a file system, exposes itself to user space 210 via a specific protocol P1 that is native to the operating system implementing the virtual unified file system. Protocol P1 is any one of multiple protocols natively supported by the operating system implementing the virtual unified file system.

A service request originating from user space 210 via specific protocol P1 is processed by file I/O module 230 within kernel space 220. A converter module 202 within file I/O module 230 converts specific protocol P1 commands into universal protocol UP commands. The remaining operational logic involved in performing a service request made to the virtual unified file system is processed through a unify unit 203 via the universal protocol UP. The conversion from a specific protocol to the universal protocol UP hides the complexity of unifying directories and individual files from multiple sub-file system, each sub-file system possibly providing different file attributes.

Unify unit 203 interacts with one or more sub-file systems through converter modules 204 and 205 which convert universal protocol UP commands to a specific protocol that is native to a specific sub-file system. As shown, converter module 204 converts universal protocol UP commands targeted to sub-file system 240 to a specific protocol P2 that is native to the target sub-file system 240. Similarly, converter module 205 converts universal protocol commands UP targeted to sub-file system 250 to a specific protocol P3 that is native to the target sub-file system 250.

As can be seen from the above description, the universal protocol UP, the converter modules 202, 204 and 205 and the unify unit 203 are integral to the implementation of the virtual unified file system. A detailed description of each of these components is provided below.

The universal protocol of the present invention must effectively express common file system operations while allowing for an arbitrary number of extensions and exceptions. The core functionalities of almost all modern file systems are basically identical consisting of creating, opening, deleting, reading and writing files and directories of files. However, each file system has unique file properties and unique protocol commands. The purpose of the universal protocol is to support all of these attributes and commands without actually adding the specific implementation of each of these attributes and commands to the protocol. The abstraction of those unique features and commands from the majority of modern file systems provides for a universal protocol whose command structure is easily translated into a specific protocol native to a specific sub-file system.

As such, the universal protocol specifies a set of operations and data structures that are a super-set of most of those features present in existing file systems. Any existing file system can be controlled through this protocol, and an implementation of the protocol can be created over any existing file system and operating system. The protocol leaves it up to the implementer whether a feature that is defined within the universal protocol but not supported by an integrated sub-file system should remain unsupported or should be emulated with features that are close to those features supported by the sub-file system. For example, an implementation of the universal protocol on top of a NTFS file system can declare that it does not support object IDs (which are not present natively in the NTFS file system) or emulate them by assigning virtual IDs to files residing under the NTFS file system. This way the universal protocol creates a layer of abstraction that hides from the user of the universal protocol details of those features supported by the underlying file systems and how they are supported.

The universal protocol can be functionally divided into a base protocol component and an extension protocol component. The base protocol includes the basic operations and commands that each modern file system implementation must support. The base protocol is designed in such a way that its implementation over an underlying file system is trivial and has almost no performance penalty. The base protocol also contains a method to inspect and implement extensions to the base protocol.

The extension protocol component of the universal protocol can itself be divided into extended attribute extensions, file ID extensions and volume IO extensions. The extended attribute extensions provide for the association of an unlimited number of named attributes to a file system object, such as a folder or file. These extensions facilitate the storage and accessing of multiple file system specific attributes through a single generic interface. For example, if a native file system needs to support a specific attribute that is not defined within the base protocol, it can use a named attribute for that, and store it regardless of whether any specific sub-file system has native support for that particular feature.

The file ID extension allows for the effective implementation of natively supported unique file object identification numbers where needed. A typical example is the implementation of native file system support for Apple's OS X operating system, which relies on the unique object identification numbers as an attribute of files. An implementation over a sub-file system that does not internally support unique file object identification numbers can emulate them or not support the extension.

The volume IO extension provides information about the layout of the file structure on a disk. It is used when the caller has an alternative path to the volume device so it can read or write data directly to it.

In order to add support for a specific file system under the universal protocol, a converter module needs to be implemented which converts universal protocol commands into the specific protocol native to the added sub-file system and conversely provides conversion from the specific protocol native to the sub-file system to the universal protocol. The design of the universal protocol itself matches as close as possible the specific protocols native to most modern file systems thereby allowing for an implementation of the converter module which does not have a significant performance overhead.

Moreover, to allow for performance optimization and to allow for support of unforeseen features, the universal protocol of the present invention provides for an extension mechanism which allows the user to implement custom commands within the universal protocol. An example of such an extension is a function which would bypass conversion to the universal protocol when the source and destination protocols are the same.

The unify unit contains the mechanism to service file system operation calls originating from the user space of the operating system to any of multiple integrated sub-file systems while presenting a single virtual unified file system comprised of the multiple integrated sub-file systems to the user space. In order to service a request, the unify unit communicates with one or more of its sub file systems depending on the type of call. For example if the request requires enumeration of a folder, the unify unit will enumerate this folder on all sub-file systems, merge the results and return the merged result to the caller. If the request requires reading data from a file, the unify unit will forward the read request to the exact sub-file system that contains that file, since it already knows where the file is.

An important part of maintaining the virtual unified file system is the mechanism for distributing the files amongst its sub-file systems. In order to achieve maximum run-time effectiveness and an optimal distribution of the files, the virtual unified file system combines run-time and off-line methods for distributing the files.

A “run-time distribution mechanism” refers to a mechanism controlling the decision on which sub file system new files are created.

An “off-line distribution mechanism” refers to a mechanism that analyses the data of number of sub file systems and performs file move operations between them to achieve optimal distribution. This process is run on a scheduled basis as a maintenance process to resolve the distribution inconsistencies caused by events (like user move or delete or rename of file) that are out of the run-time mechanisms' control.

A “distribution strategy” refers to a combination of a run-time distribution mechanism and an off-line distribution mechanism that are designed to work together to control file distribution with a common goal.

A “soft limit” refers to a user-configurable percent of the available space on a sub file system above which the distribution mechanisms consider this sub file system full and stop creating new files there.

“Affinity” refers to a user-configurable setting per sub file system defining what file types should be stored on that sub file system.

A “near-line target” refers to a user-configurable setting defining for a sub file system a sub file system that older files must go to under the last modified distribution strategy. This means that for a fast, small sub file system the near-line target is usually a slow, big sub file system.

The present invention defines (but is not limited to) four distribution strategies:

Fill up—the sub file systems are ordered and are filled up according to that order. When space runs out on the first one continue on the second etc.

Harmonize—the files are distributed so that folders group them as much as possible. The goal of this distribution strategy is that the number of folders that have contents on more than one sub file system is minimized.

File type—the files are distributed by their type. For each sub file system the user can define what type of files it can store.

Last modified—this distribution strategy is designed for unification of small, fast storages with big, slow storages. It works similar to fill-up, but moves frequently used files to the fast storage so that they are accessed faster. The virtual unified file system works from a user perspective as one fast, big storage.

A key element of the virtual unified file system of the present invention is that, unlike existing file systems where data flows from file system to block device, data in the virtual unified file system flows from one file system to another file system. As shown in FIG. 2, when an application makes a file system call through the logical I/O system 211 the call is sent to the file I/O module 230 in kernel space 220. The call is first translated within converter module 202 from the operating system's native file system protocol P1 command to a universal protocol UP command. The universal protocol UP command is then executed in unify unit 203, which in turn makes a call to a specific integrated sub-file system using the universal protocol. The universal protocol UP commands are then translated to a specific native protocols P2 and P3 within converter modules 204 and 205 before making the actual call on either of the sub-file system 240 and 250. At this stage, it is the sub-file system 240 and 250 which accesses block devices thereby generating a result to the call. The result of the call on sub-file systems 240 and 250 travels back to converters 204 and 205 which translate the result from native protocols P2 and P3 to the universal protocol UP and then provide the translated results to unify unit 203. Unify unit 203 will process the translated results based on the command and return a result in universal protocol UP to converter module 202. Converter module 202 converts the universal protocol UP result into a native protocol P1 result. Therefore, data flow through the virtual unified file system is only between the file I/O module of the virtual unified file system and integrated sub-file systems.

Since the virtual unified file system does not access physical block devices, a set of physical devices making up a sub-file system may be disconnected from a system implementing a virtual unified file system and reconnected to a different system. The block devices will simply appear as a normal file system on that system. There is no data loss associated with this operation. Of course the data contained on this physical device will no longer be accessible through the original virtual unified file system, which will now only be comprise of the remaining sub-file system. As long as one sub-file system is available, the virtual unified file system will remain mounted. If the set of physical device is reconnected back to the original system, it will automatically remount as part of the original virtual unified file system it still belongs.

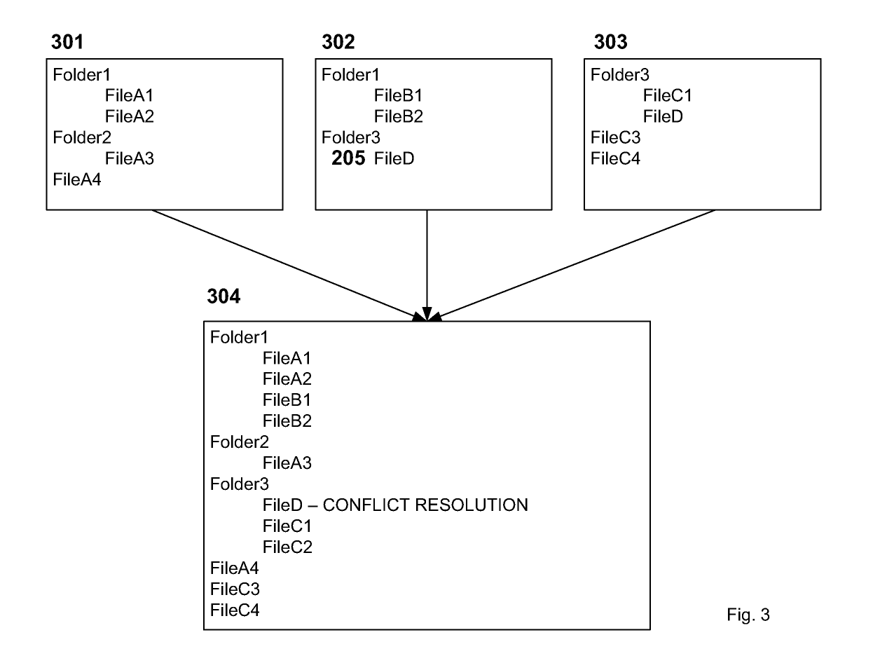

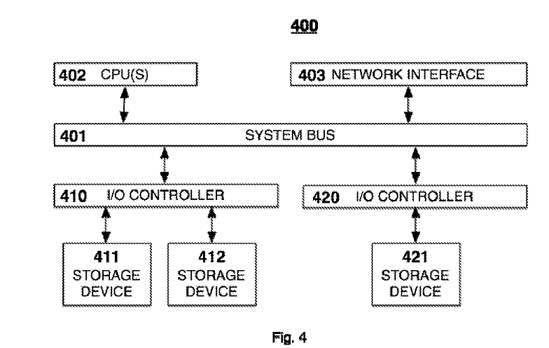

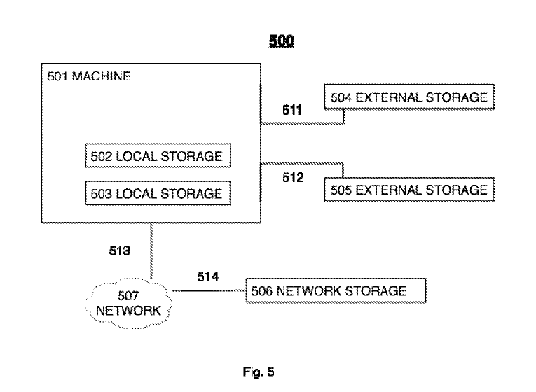

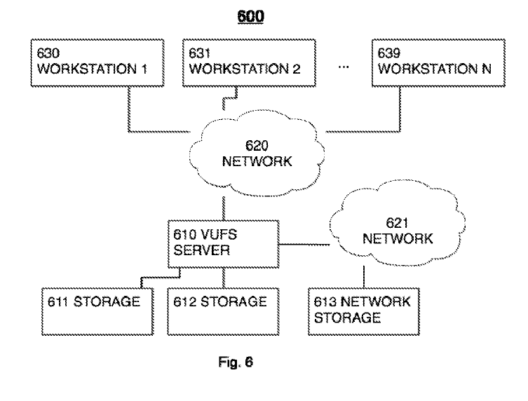

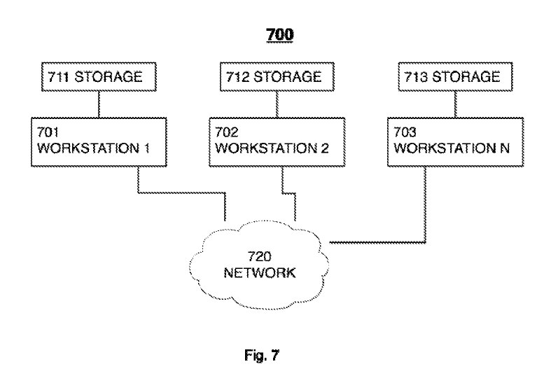

FIG. 3 is a functional block diagram of one possible embodiment of how sub-file systems integrated within a virtual unified file system are presented to the user space. As shown, three sub-file systems are merged into a virtual unified file system. Specifically, the directory and file structures of sub-file system 301, sub-file system 302 and sub-file system 303 are merged under a single virtual unified file system 304, the virtual unified file system presenting to the user a single virtual unified directory and file structure.

The general rule for merging the sub file systems into a virtual unified file system is that, if possible, the file path to any file is the same in both the sub-file system and the virtual unified file system. This is not possible when there is a file with the exact same path on more than one of the sub-file systems. If this is the case, the unification mechanism must resolve the conflict, since there cannot exist two identical paths in the resulting virtual unified file system. The virtual unified file system allows for two general types of conflict resolution, the system resolves to show only one of the files under the virtual unified file system or the system resolves to show all the files under the virtual unified file system.

In the case where conflicting paths result in one path under the virtual unified file system, there must be consistent criteria by which one of the sub file system paths is associated with the single path in the virtual unified file system. Examples of such criteria are “the last modified”, “the first in sub file system order”, “the biggest”, etc.

In the case where the virtual unified file path must provide access to all conflicting paths, it needs to make the paths unique by modifying the names of the files (which are part of the path). This is done by appending a unique string (per sub file system) to the end of the name. This string can be anything as long as it is guaranteed to be unique for each sub file system. The exemplary embodiment of the present invention uses GUID for that purpose.

In the current implementation, multiple virtual unified file systems can co-exist and be mounted by the operating system. Each virtual unified file system contains different sub-file systems. A given file system can only participate in one virtual unified file system. A sub-file system can be removed from a virtual unified file system. In this case, it becomes a file system again. There is no data loss when adding or removing a file system to and from a virtual unified file system.

A software allows the user to create any number of virtual unified file system. Upon creation, these virtual unified file systems contain no sub-file system and cannot be mounted on the operating system. At least one sub-file system must participate in a virtual unified file system so it can be mounted by the OS. The user must declare which existing file system will become a sub-file system for a given virtual unified file system.

When creating a new virtual unified file system, all available file systems mounted on the operating system that are not already part of a virtual unified file system are presented to the user. Any number of file systems can be selected. Once selected, they are turned into sub-file systems and assigned to the selected virtual unified file system. In the current implementation, a hidden file is stored on the root of these individual sub-file systems. This file contains a unique GUID describing what virtual unified file system it belongs to.

The user is given the option to either hide or keep the original file systems mounted after it has become part of a virtual unified file system. The default option is to hide them to minimize confusion. However, in some cases, it might be useful to keep the individual sub-file systems mounted on the OS. In this case, the sub-file system is also a file system for the operating system.

By default, all virtual unified file systems are automatically mounted on the local operating system at boot time. The user does not need to interact with the individual sub-file systems or the software. Only the system administrator is expected to make an initial configuration of the software to implement or delete the virtual unified file system, to add or remove sub-file systems as well as assign run-time distribution or off-line optimization strategies.

Given the organizational benefits associated with storing all information inside a single volume, instead of searching through multiple volumes, there is a decisive trend toward very large volumes. Unfortunately, very large volumes are exposed to file system corruption the same way a smaller volume is. Even with sound maintenance and backup procedures, one cannot be totally immune from this type of incidents.

The larger the file system, the longer it takes to restore it in case of a problem. Instead of creating a single very large file system, that is error prone and difficult to manage, the virtual unified file system approach allows one to create any number of smaller file systems. These file systems can then become sub-file systems participating in a very large virtual unified file system. When a virtual unified file system needs to be expanded, one only need to format a new file system that can then be added to an existing virtual unified file system. All this new space instantly becomes available to the user through the virtual unified file system.

Similarly, if there is extra storage capacity in an existing virtual unified file system that should be made available for another system without affecting the current data store, the system administrator can use off-line optimization tools to transfer content from one sub-file system to other sub-file systems. As long as there is enough available space on the remaining sub-file systems to store the content of the sub-file system that must be freed, the operation will be totally transparent to the users accessing the virtual unified file system. When the sub-file system has been emptied from its content, it can safely be removed from the virtual unified file system and re-deployed somewhere else or simply retired.

The risks of data loss associated with a corrupted file system are also greatly reduced, as statistically, only one of the sub-file systems is likely to fail at any given time. The remaining file systems would remain online and healthy. As a result, only the data stored on the defective sub-file system will become unavailable, until the sub-file system is restored through standard procedures.

Exemplary apparatuses and systems implementing the virtual unified file system will now be described.

FIG. 4 is a high-level block diagram of a machine 400 that is an exemplary apparatus implementing the virtual unified file system. The machine 400 includes one or more central processing units 402, one or more I/O controllers 410, 420 and a network interface 403 connected to a common system bus 401. Each of the I/O controllers 410, 420 can have one or more storage devices 411, 412, 421 connected to it.

In the machine, each of the storage devices connected 411, 412, 421 to the machine through the I/O controllers 410, 420 and the system bus 401 has one or more separate file systems. For example one such machine can have several SCSI hard disks with different file systems on them, some USB flash memory devices with other file systems and mount network storage file systems through the network interface 403. The operating system on the machine provides applications with means of accessing these multiple file systems. For an application accessing a specific file system, the application must identify which file system it wants to access and the operating system will use bus-specific instructions or use the network interface to perform I/O operations on the storage device this file system resides on.

For the implementation of a virtual unified file system the one or more CPU(s) 402 execute machine instructions that implement the virtual unified file system which communicate over the system bus 401 to the I/O controllers 410, 420 and optionally the network interface 403. The machine instructions operate through an operating system, which provide standardized access to the peripheral devices such as I/O controllers 410, 42 and the network interface 403.

In one embodiment, the machine 400 may be a conventional personal computer. In this case, the central processing units 402 may be one or more microprocessors. The bus 401 may be a common PCI system bus. The storage controllers 410, 420 may include SCSI, SATA, FireWire or USB standard controllers. The storage devices 411, 412, 421 may include SCSI, SATA or SSD disks, flash-based USB devices or external FireWire disks.

The storage devices 411, 412, 421 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

The network interface 403 may be any standard network interface card (NIC) equipment compatible with the specific system bus 401.

FIG. 5 illustrates an environment 500 in which the present invention may be used. A machine 501 may include any number of internal storages 502, 503, any number of external storages 504, 505 and be connected through a network 507 to any number of network-attached storages 506. The machine can run any operating system.

The internal storage devices 502, 503 may be hard disks, solid-state disks, connected through a common bus (SCSI, IDE).

The external storage devices 504, 505 may be hard disks, RAID arrays, flash memory devices. They can be connected to the machine 501 through different interfaces 511, 512 such as USB, Fiber Channel, and FireWire.

The network-attached storages 506 may be any other machine or a dedicated device sharing storage through a network protocol 513, 507, 514 such as SMB or AFP.

Each of the storages in the diagram 502, 503, 504, 505, 506 may have different layout of the file data on it, known as a file system. Popular file systems include NTFS, FAT, FAT32, HFS+, ZFS, XFS. Each file system implements different file system protocol.

On such an environment 500 the virtual unified file system is used to unify any number of the file systems on the different storages 502, 503, 504, 505, 506 and present a virtual unified file system to the applications running on the machine 501. This enables all applications run on that machine to use the virtual unified file system to access files independent of their actual location.

FIG. 6 illustrates an environment 600 in which the present invention may be used. A machine implementing the virtual unified file system 610 may have any number of locally attached storages 611, 612 and/or have access to any number of network-attached storages 613 through a network 621. This machine 610 may implement a virtual unified file system on a selected number of storages is has access to and share its virtual unified file system over a network 620 so that any number of network-attached workstations 630, 631 . . . 639 can work with the arbitrary number of physical storages in a unified way.

In this scenario, only one machine 610 implements the virtual unified file system and all other workstations 630, 631 . . . 639 can access it through the network without having the virtual unified file system executing on their processors.

The machine 610 may be running under a modern operating system such as Microsoft Windows, Unix/Linux or Mac OS X. It may share the virtual unified file system using a standard network storage sharing protocol such as SMB, AFP or NFS. The workstations may be running any operating system that supports the chosen network storage sharing protocol such as Microsoft Windows, Unix/Linux or Mac OS X.

FIG. 7 illustrates an environment 700 in which the present invention may be used. An arbitrary number of machines 701, 702, 703 may have one or more local storages 711, 712, 713. All machines are connected to the same network 720. Each machine shares its storage through the network to all other machines. Each machine implements a virtual unified file system unifying its locally attached storage with the storages shared from the other machines.

The machines 701, 702, 703 may be running under a modern operating system such as Microsoft Windows, Unix/Linux or Mac OS X. The storages 711, 712, 713 may be internal or external, and may be connected to the machines through various means such as IDE, SCSI, USB, Fiber Channel. They may share their storages 711, 712, 713 using a standard network storage sharing protocol such as SMB, AFP or NFS.

In this scenario, each machine can access through the virtual unified file system the union of all local storages, enabling applications to use all the storages 711, 712, 713 as one big, unified storage. This enable data sharing and collaboration between the machines 701, 702, 703 without a central storage and a dedicated server for that storage.

Attached Appendix A includes additional information and discussion of the present invention and includes exemplary code that may be utilized to implement the present invention. Appendix A is incorporated herein by reference as if specifically set out.

What is claimed:

1. A series of instructions on a non-transitory storage medium accessible to a computer, the instructions causing the computer to implement a virtual unified file system comprising:
an operating system module implementing an operating system specific protocol and mounting the virtual unified file system via the operating system specific protocol;
a logical file storage interface module within the virtual unified file system processing logical file storage calls originating from the operating system using the operating system specific protocol to one or more independent sub-file systems implementing block-based storage devices;
converter modules within the virtual unified file system converting between the operating system specific protocol and a universal protocol and converting between the universal protocol and multiple file system specific protocols implemented by the one or more independent sub-file systems, and
a unify module within the virtual unified file system operating on the universal protocol to perform operational logic necessary to implement service requests by issuing one or more requests to each of the independent sub-file systems and generating a unified result for a logical file storage call originating from the operating system using the operating system specific protocol.

2. The series of instructions on a non-transitory storage medium accessible to a computer of claim 1 wherein the file system specific protocols are implemented on multiple operating systems including Windows, OS X, Linux and Unix.

3. The series of instructions on a non-transitory storage medium accessible to a computer of claim 1 wherein the operating system specific protocol is implemented on multiple operating systems including Windows, OS X, Linux and Unix.

4. The series of instructions on a non-transitory storage medium accessible to a computer of claim 1 wherein the operating system module automatically mounts the virtual unified file system when the computer boots up.

5. The series of instructions on a non-transitory storage medium accessible to a computer of claim 1 wherein the universal protocol includes a base component providing for the basic operations and commands of a modern file system and an extension component implementing file system features not common in the modern file system.

6. The series of instructions on a non-transitory storage medium accessible to a computer of claim 5 wherein the base component adds a minimal performance penalty to the performance of the one or more independent sub-file system.

7. The series of instructions on a non-transitory storage medium accessible to a computer of claim 5 wherein the extension component includes
an extended attribute extension providing for the association of an unlimited number of named attributes to an independent sub-file system object;
a file ID extension providing for the implementation of natively supported unique file object identification numbers; and
a volume ID extension providing identification of block-based volumes across each of the independent sub-file systems.

8. The series of instructions on a non-transitory storage medium accessible to a computer of claim 5 wherein the extension component includes a function which bypasses the converter modules when a source file system protocol and a destination file system protocol are the same.

9. The series of instructions on a non-transitory storage medium accessible to a computer of claim 1 wherein the unify module provides to the operating system module access to those features and capabilities that are common to each of the one or more independent sub-file systems.

10. The series of instructions on a non-transitory storage medium accessible to a computer of claim 1 wherein the unify module
enumerates, in response to a request from the logical file storage module which requires an enumeration of a folder, all folders on each of the one or more independent sub-file systems and returns a merged result and
forwards, in response to a request from the logical file storage module to read data from a file, a read request to an independent sub-file system containing the file.

11. The series of instructions on a non-transitory storage medium accessible to a computer of claim 1 wherein the unify module includes a combination of run-time and off-line mechanisms for distribution of files,
the run-time mechanism controlling on which of the one or more independent sub-file systems new files are created and
the off-line mechanism controlling file move operations between the one or more independent sub-file systems to achieve a desired distribution.

12. The series of instructions on a non-transitory storage medium accessible to a computer of claim 11 wherein the unify module distributes files based on a defined strategy, the defined strategy including
a fill-up strategy wherein the one or more independent sub-file systems are ordered and filled up according to that order,
a harmonize strategy wherein files are distributed so that the number of folders containing the same files on more than one of the one or more independent sub-file systems is minimized,
a file-type strategy wherein files are distributed according to their file-type, and
a last modified strategy wherein frequently accessed files are stored on those independent sub-file systems with faster access times and less frequently accessed files are stored on those independent sub-file systems with slower access times.

13. The series of instructions on a non-transitory storage medium accessible to a computer of claim 1 wherein the virtual unified file system provides for the addition and removal of each of the one or more independent sub-file systems without a loss of data.

14. The series of instructions on a non-transitory storage medium accessible to a computer of claim 1 wherein the unify module provides a file path to any file under the virtual unified file system equivalent to that file's path under an independent sub-file system unless there is a file with the exact same path on more than one of the one or more independent sub-file systems in which case the unify module resolves the conflict by amended the presented file path according a defined criteria.

15. The series of instructions on a non-transitory storage medium accessible to a computer of claim 1 wherein the virtual unified file system provides the unified result generated by the unify module to other computers not implementing a virtual unified file system via a communication network connecting the computer implementing the virtual unified file system and the other computers.

16. A computer-implemented method for controlling the presentation of a virtual unified file system, the method comprising:
implementing an operating system specific protocol within an operating system;
mounting the virtual unified file system via the operating system specific
protocol;
processing by a logical file storage module within the virtual unified file system of logical file storage calls originating from the operating system using the operating system specific protocol to one or more independent sub-file systems implementing block-based storage devices;
concerting by converter modules within the virtual unified file system between the operating system specific protocol and a universal protocol and converting between the universal protocol and multiple file system specific protocols implemented by the one or more independent sub-file systems; and
operating on the universal protocol by a unify module within the virtual unified file system to perform operational logic necessary to implement service requests by issuing one or more requests to each of the one or more independent sub-file systems and generating a unified result for a logical file storage call originating from the operating system using the operating system specific protocol.

17. The computer-implemented method for controlling the presentation of the virtual unified file system of claim 16 wherein the file system specific protocols are implemented on multiple operating systems including Windows, OS X, Linux and Unix.

18. The computer-implemented method for controlling the presentation of the virtual unified file system of claim 16 wherein the operating system specific protocol is implemented on multiple operating systems including Windows, OS X, Linux and Unix.

19. The computer-implemented method for controlling the presentation of the virtual unified file system of claim 16 wherein mounting the virtual unified file system via the operating system specific protocol is automatic when the computer boots up.

20. The computer-implemented method for controlling the presentation of the virtual unified file system of claim 16 wherein the universal protocol includes a base component providing for the basic operations and commands of a modern file system and an extension component implementing file system features not common in the modern file system.

21. The computer-implemented method for controlling the presentation of the virtual unified file system of claim 16 wherein the base component adds a minimal performance penalty to the performance of the one or more independent sub-file systems.

22. The computer-implemented method for controlling the presentation of the virtual unified file system of claim 20 wherein the extension component includes
an extended attribute extension providing for the association of an unlimited number of named attributes to an independent sub-file system object;
a file ID extension providing for the implementation of natively supported unique file object identification numbers; and
a volume ID extension providing identification of block-based volumes across each of the one or more independent sub-file systems.

23. The computer-implemented method for controlling the presentation of the virtual unified file system of claim 20 wherein the extension component includes a function which bypasses the converter modules when a source file system protocol and a destination file system protocol are the same.

24. The computer-implemented method for controlling the presentation of the virtual unified file system of claim 16 wherein the unify module provides to the operating system module access to those features and capabilities that are common to each of the one or more independent sub-file systems.

25. The computer-implemented method for controlling the presentation of the virtual unified file system of claim 16 wherein the unify module
enumerates, in response to a request from the logical file storage module which requires an enumeration of a folder, all folders on each of the one or more independent sub-file systems and returns a merged result and
forwards, in response to a request from the logical file storage module to read data from a file, the read request to an independent sub-file system containing the file.

26. The computer-implemented method for controlling the presentation of the virtual unified file system of claim 16 wherein the unify module includes a combination of run-time and off-line mechanisms for distribution of files,
the run-time mechanism controlling on which of the one or more independent sub-file systems new files are created and
the off-line mechanism controlling file move operations between the one or more independent sub-file systems to achieve a desired distribution.

27. The computer-implemented method for controlling the presentation of the virtual unified file system of claim 26 wherein the unify module distributes files based on a defined strategy, the defined strategy including
a fill-up strategy wherein the one or more independent sub-file systems are ordered and filled up according to that order,
a harmonize strategy wherein files are distributed so that the number of folders containing the same files on more than one of the one or more independent sub-file system is minimized,
a file-type strategy wherein files are distributed according to their file-type, and
a last modified strategy wherein frequently accessed files are stored on those independent sub-file systems with faster access times and less frequently accessed files are stored on those independent sub-file systems with slower access times.

28. The computer-implemented method for controlling the presentation of the virtual unified file system of claim 16 wherein the virtual unified file system provides for the addition and removal of each of the one or more independent sub-file system without a loss of data.

29. The computer-implemented method for controlling the presentation of the virtual unified file system of claim 16 wherein the unify module provides a file path to any file under the virtual unified file system equivalent to that file's path under an independent sub-file system unless there is a file with the exact same path on more than one of the sub-file systems in which case the unify module resolves the conflict by amended the presented file path according a defined criteria.

30. The computer-implemented method for controlling the presentation of the virtual unified file system of claim 16 wherein the unify module provides the generated unified result to other computers not implementing the virtual unified file system via a communication network connecting the computer implementing the virtual unified file system and the other computers.
